(19) United States
(12) Patent Application Publication
(10) Pub. No.: US 2022/0000258 A1
(43) Pub. Date: Jan. 6, 2022

(54) MULTI-FUNCTIONAL CRADLE

(71) Applicant: Seong Won KIM, Ulsan (KR)

(72) Inventor: Seong Won KIM, Ulsan (KR)

(21) Appl. No.: 17/296,251

(22) PCT Filed: Nov. 25, 2019
(86) PCT No.: PCT/KR2019/016297

§ 371 Date: May 23, 2021

(30) Foreign Application Priority Data
Nov. 23, 2018 (KR) 10-2018-0146825
Nov. 28, 2018 (KR) 10-2018-0149191
Jan. 12, 2019 (KR) 10-2019-0004293
Jun. 16, 2019 (KR) 10-2019-0071195
Jun. 18, 2019 (KR) 10-2019-0071891
Oct. 11, 2019 (KR) 10-2019-0126540
Nov. 8, 2019 (KR) 10-2019-0142253
Nov. 9, 2019 (KR) 10-2019-0143075
Nov. 12, 2019 (KR) 10-2019-0144646
Nov. 14, 2019 (KR) 10-2019-0145493
Nov. 22, 2019 (KR) 10-2019-0150877
Nov. 25, 2019 (KR) 10-2019-0152683
Nov. 25, 2019 (KR) 10-2019-0152684

(51) Int. Cl. A47B 23/04; A47B 23/06

(52) U.S. Cl. CPC A47B 23/043; A47B 23/06

(57) ABSTRACT

A multi-functional cradle includes; a top plate that supports the item to be placed on one side; a bracket provided to protrude from a lower portion of one surface of the top plate to support a lower portion of the item; an auxiliary plate which is pulled out from the upper part of the upper plate and includes an auxiliary bracket for supporting another item to be placed; And a bottom plate unfolded to support the top plate at the rear surface of the top plate.

### TECHNICAL FIELD

This invention is about multi-functional cradle. More specifically, this invention is about multi-functional cradle having a auxiliary plate, in which this invention can adjust the height of the cradle for items such as books, can stand electric devices or other items separately as well as books, and can be used in narrow space by being folded a bottom plate

### BACKGROUND ART

In general, a reading stand, which is a kind of cradle, adjusts the angle of the top plate and the bracket, and guides reading in a correct posture by leaning the book on the bracket on the side of the top plate. Therefore, it is used to make a posture with a head lowered rather than to open a book on the floor of a desk.

As an example of the prior art, a ‘reading stand’ of the Korea Patent Registration No. 10-0579425 and a ‘reading stand support structure capable of adjusting the support length’ of the Korea Patent Registration No. 10-1767917 was disclosed.

The reading stand of the first prior art is a form in which two reading stands are combined up and down. Therefore, there is a disadvantage in that portability is inconvenient. And the reading stand of the second prior art has a plate-shaped rod structure. Therefore, there is a disadvantage that the support structure is unstable.

In addition, since the reading stand of the prior art does not have a separate auxiliary plate, there is no means for placing other books or electronic devices such as mobile phones in addition to the books on the top plate and using them together. In addition, in order to unfold the reading table in a narrow desk, the length of the bottom plate may make it uncomfortable to use the desk due to the narrow desk area after unfolding the reading stand.

As described above, there is a need for a new cradle that can compensate for the disadvantages of the reading stand of the prior art.

### DISCLOSURE

### Technical Problem

The present invention is to solve the problems of the prior art described above, and an object of the present invention is to provide a multifunctional cradle having a bracket and an auxiliary plate that is easy to carry and can be used by adjusting the height of an item to be standed.

Another object of the present invention is to provide a multifunctional cradle having an auxiliary plate that is easy to carry and can additionally stand other items in addition to the basic objects such as books.

Another object of the present invention is to provide a multifunctional cradle having an auxiliary plate that is easy to carry and can be used conveniently and stably by folding a bottom plate in a one-touch manner in a narrow space.

### Technical Solution

The multifunctional cradle according to the present invention conceived to achieve the above object includes a top plate, a bracket, a fixing device, and a clip. The top plate supports the item on one surface thereof. And the bracket is provided so as to protrude from one surface of the top plate and to support the lower portion of the item, and is coupled with a clip to move up and down along the clip rail. The fixing device may fix the height of the bracket, and the clip couples the fixing device with the top plate and the bracket and moves up and down along the clip rail.

In addition, the clip rail of the upper plate includes a rail fixing groove formed therein to fix the height of the bracket by using a fixing device. The fixing device provided on the clip may include a button, a rail fixing clip, and an elastic member. The button has a rail fixing protrusion and may be inserted into the rail fixing clip. The rail fixing clip has a button insertion groove so that a button can be inserted. The elastic member is located in the button insertion groove of the rail fixing clip or button, and provides an elastic force to the button so that the rail fixing protrusion of the button may be inserted into the rail fixing groove. The position of the elastic member can be changed. In addition, the position or number of the clip rails or buttons on the top plate can be changed. In addition to the left and right sides of the upper plate, it may be provided in a single or plural number on the left and right inner or outer sides of the upper plate.

In addition, it is possible to adjust the height of the clip or the bracket by using the elastic force of an elastic body such as a plate spring formed in the clip without a button. That is, since there is an elastic body such as a plate spring inside the clip, the entire clip acts as a button.

Therefore, when the clip is pressed, the rail fixing protrusion moves away from the rail fixing groove by the elastic force of the elastic body inside the clip.

This makes the height of the clip and bracket adjustable. And if the force applied to the clip is removed, the rail fixing protrusion engages and fixes the rail fixing groove again. Otherwise, if the clip or the bracket is moved by applying a force up and down without pressing the clip, the elastic force of the elastic body such as a plate spring inside the clip is adjusted by the force, so that the height of the clip and the bracket can be adjusted.

A cradle having an auxiliary plate according to an aspect of the present invention for solving the above technical problem (hereinafter, referred to as a ‘cradle’) includes a top plate, a bracket, and an auxiliary plate. The top plate supports the item to be mounted on one surface thereof, the bracket is provided to protrude from one surface of the top plate to support the lower portion of the item, and the auxiliary plate is pulled out to the top plate and includes an auxiliary bracket, a rotation hinge, and a fixing means. The auxiliary bracket supports another item to be mounted, the rotation hinge serves to adjust the angle of the auxiliary plate while coupling the upper auxiliary plate and the lower auxiliary plate, and the fixing means fixes the adjusted height of the auxiliary plate.

The auxiliary plate has an auxiliary bracket. The auxiliary bracket may stand electronic devices such as a smart phone or other items. A rotation hinge is formed at the lower end of the auxiliary bracket, and an insertion groove into which the auxiliary bracket can be inserted is formed in the auxiliary plate. Therefore, when the auxiliary bracket is not used, the auxiliary bracket can be inserted into the insertion groove.

In addition, the auxiliary plate is divided into an upper auxiliary plate and a lower auxiliary plate, and can connected between them using a rotation hinge. Using the rotation hinge, it is possible to adjust the inclination angle of the auxiliary plate separately from the inclination angle of the top plate. Therefore, user convenience can be increased by adjusting the auxiliary plate according to the user's viewing angle.

In addition, the auxiliary plate is provided with a fixing means for fixing to the moved position after the auxiliary plate is slid up and down. The locking protrusion formed at the lower end of the auxiliary plate is caught in one or more of locking bump grooves formed in the top plate and is fixed at a lifted height. Naturally, the positions of the locking protrusion and the locking bump groove can be interchanged. In this case, the locking protrusion may be performed by a fixing ball having an elastic body instead.

In addition, the cradle having the auxiliary plate may further include a pantograph installed inside or outside the top plate and coupled to the lower end of the auxiliary plate in the lifting direction of the auxiliary plate.

In addition, the auxiliary plate is installed on the inner surface or the rear surface of the top plate, and is slid up and down in the vertical direction to be positioned so as not to protrude from the upper plate or to be lifted to protrude.

In addition, by forming a separate book holder on the auxiliary bracket of the auxiliary plate, it is possible to hold a page of the book when placing the book on the auxiliary plate.

In addition, a wireless charging unit using a coil and a PCB circuit board may be provided on the auxiliary plate to enable wireless charging when the electronic portable device is mounted on the auxiliary plate.

The cradle according to another aspect of the present invention for solving the above technical problem includes a top plate, a bracket and a bottom plate. The top plate supports the item to be mounted on one surface thereof, the bracket is provided to protrude from one surface of the top plate to support the lower portion of the item. The bottom plate is configured to be folded with a hinge on the rear surface of the top plate, and is unfolded to support the top plate on the rear surface of the top plate. The bottom plate is composed of an upper bottom plate and a lower bottom plate, and the upper and lower bottom plates are coupled by a hinge part, and the bottom plate may be folded or unfolded by a fixing lock device.

The bottom plate includes an upper bottom plate and a lower bottom plate, and the upper bottom plate and the lower bottom plate are rotatable by a rotation hinge, so that the bottom plate can be folded or unfolded. A fixing lock device capable of folding or fixing the upper and lower bottom plates is provided inside the rotation hinge of the bottom plate. When the fixing bar is located in the fixing lock groove on the upper hinge part (hinge part of the upper bottom plate) by the elastic force of the fixing bar, if the fixing bar is moved to the spring groove in the direction of the lower hinge part (the hinge part of the lower bottom plate) while compressing the spring by external force, the fixing bar moves from the fixing lock groove. Thus, the lock state of the bottom plate is released. Accordingly, the lower bottom plate can be rotated with respect to the upper bottom plate to be superimposed on the upper bottom plate. At this time, the fixing bar contacts one surface of the upper hinge part and rotates together with the rotation of the lower bottom plate. And if the folded lower bottom plate is rotated 180 degrees and unfolded again, it is automatically locked and the bottom plate can be fixed. That is, as the lower bottom plate rotates, the fixing bar also rotates, and when the lower bottom plate is unfolded by 180 degrees, the fixing bar meets the fixing lock groove on the upper hinge part. Accordingly, the fixing bar is inserted into the fixing lock groove and fixed by the elastic force of the elastic body formed in the lower hinge part.

Meanwhile, in the present invention, it is exemplified that the fixing lock groove is formed in the upper hinge part, and the spring groove is formed in the lower hinge part of the lower blood plate, but the present invention is not limited thereto. In addition, although not shown, the fixing lock groove may be formed on the lower hinge part of the lower bottom plate, and the spring groove may be formed on the upper hinge part of the upper bottom plate. In addition, the fixing bar lock device of the hinge device described above may be installed only on one side or both sides of the bottom plate.

In another embodiment, it is possible to implement a button-type fixing lock device provided with a fixing protrusion instead of a fixing bar. That is, a button having a spring and a fixing protrusion inside the upper hinge part and the lower hinge part may be coupled.

When the button protruding out of the upper hinge part is pressed, the fixing protrusion of the button comes out of the fixing groove formed inside the upper hinge part and is inserted to the end of the seating groove formed inside the lower hinge part. The bottom plate in which the lock is released can be rotated so that it can be folded.

Here, when the button is pressed by the action of a spring that accumulates elastic force due to twisting, the lower bottom plate can be automatically folded on the upper floor plate.

To unfold the folded bottom plate again, unfold the lower bottom plate overlaid on the upper bottom plate in a clockwise direction 180 degrees while the lock is released by pressing the button. Then, while the fixing protrusion rotates with the lower bottom plate, the fixing protrusion meets the fixing groove at some point, and is inserted into the fixing groove by the elastic force of the spring. As a result, the bottom plate is automatically locked.

At this time, if the inclined surface formed on the fixing bump of the upper hinge part is used, the bottom plate can be unfolded without pressing a button when unfolding the folded bottom plate.

On the other hand, although not shown, the fixing groove and the inclined surface may be formed in the lower hinge part, and the seating groove may be formed in the upper hinge part. That is, the formation positions can be changed to each other.

### Advantageous Effects

In the case of using the cradle having the above-described auxiliary plate, the height of the item to be mounted by raising the bracket may be adjusted according to the eye level, or the auxiliary plate may be unfolded to stand an electronic device such as a phone or other items. In addition, in a narrow space, the bottom plate can be folded so that the cradle can be used even in a narrow space.

In addition, according to the present invention, a rotation hinge is formed on the bottom plate, so that the lower bottom plate can be easily folded on the upper bottom plate by a push button method. And it is possible to simply lift and unfold the lower floor plate from the upper floor plate through the inclined surface of one side of the fixing groove in the push button.

In addition, according to the present invention, a charging coil capable of charging a portable device, a charger board, and an integrated circuit (IC) can be mounted inside the auxiliary plate or the top plate. Through this, if the electronic device is placed on the auxiliary plate, it can be charged wirelessly.

In addition, a charging coil and a wireless charging circuit board are formed on an auxiliary plate or an top plate, and a power port is formed in a specific part of the cradle, so that power can be supplied by plugging in a charging adapter. In addition, if the portable device is placed in the portion where the charging coil is located, the mobile device can be charged wirelessly. In addition, overcharging and overcurrent of portable devices can be prevented by using an integrated circuit on a circuit board. In addition, a display unit such as a light emitting diode (LED) may be arranged to indicate whether the portable device is being charged or fully charged.

### DESCRIPTION OF DRAWINGS

FIG. 1 is a perspective view of a cradle having an auxiliary plate according to the present invention and having a height adjustment function capable of adjusting the height of the bracket with a button,

FIG. 2 is a perspective view showing a state in which the auxiliary bracket of the auxiliary plate is accommodated in the auxiliary bracket insertion groove in FIG. 1;

FIG. 3 is a perspective view showing the inside of the top plate in FIG. 1.

FIG. 4 is a front view of the cradle in FIG. 3,

FIG. 5 is a view showing an enlarged view of the button and the rail fixing clip of the cradle in FIG. 1,

FIG. 6 is a perspective view showing another form of the height adjustment configuration of the bracket in the present invention.

FIG. 7 is a cross-sectional perspective view of a part of the fixing device in FIG. 6 cut in the longitudinal direction.

FIG. 8 is a cross-sectional view of a portion of the fixing device in FIG. 6 cut in the transverse direction.

FIG. 9 is a main part showing another form of the height adjustment configuration of the bracket in the present invention.

FIG. 10 is a rear view of the clip viewed from the back of the top plate in FIG. 9,

FIG. 11 is a perspective view of the clip viewed in front of the topr plate in FIG. 9,

FIG. 12 is a perspective view showing an installation state of the plate spring of the clip in FIG. 9;

FIG. 13 is a perspective view showing another form of height adjustment configuration of the auxiliary plate in the present invention.

FIG. 14 is a perspective view showing another form height adjustment configuration of the auxiliary plate in the present invention

FIG. 15 is a perspective view of a state in which the auxiliary plate is inserted into the auxiliary plate insertion part in FIG. 14;

FIG. 16 is a perspective view showing another form of the auxiliary plate insertion part in the present invention.

FIG. 17 is a perspective view showing another form of the auxiliary plate insertion part in the present invention.

FIG. 18 is a perspective view showing another form of the auxiliary plate in the present invention.

FIG. 19 is a perspective view showing another form of the auxiliary plate in the present invention.

FIG. 20 is a perspective view of the cradle in FIG. 19 as viewed from the back.

FIG. 21 is a block diagram of a wireless charging unit that can be applied in the cradle in FIG. 20;

FIG. 22 is a rear perspective view of a cradle having a hinge device for a bottom plate in the present invention.

FIG. 23 is a rear view showing a state in which the bottom plate is folded and in close contact with the rear surface of the top plate in FIG. 22.

FIG. 24 is a side view of the cradle in which the auxiliary plate is pulled out from the inside of the upper plate, and then the auxiliary bracket is unfolded and the angle of the auxiliary plate is adjusted, and the side view of the cradle showing the angle support supported in the fixing bump groove formed on the lower portion of the lower bottom plate by folding the lower bottom plate on the upper bottom plate,

FIG. 25 is a disassembled perspective view showing a push button and a spring in FIG. 28;

FIG. 26 is a perspective view showing a lower auxiliary plate hinge part in FIG. 28;

FIG. 27 is a perspective view showing an upper auxiliary plate hinge part in FIG. 28;

FIG. 28 is a perspective view showing another form of a hinge device, and an inner perspective view showing a state in which the upper and lower bottom plates are unfolded at 180 degrees and locked.

FIG. 29 is an internal perspective view of a state in which a push button of a hinge device is pressed.

FIG. 30 is an internal perspective view showing a state in which the lower floor plate is folded on the upper bottom plate.

### MODES OF THE INVENTION

Hereinafter, preferred embodiments of the present invention will be described in detail with reference to the accompanying drawings. First of all, in adding reference numerals to elements of each drawing, it should be noted that the same elements have the same reference numerals as possible, even if they are indicated on different drawings. In addition, in describing the present invention, when it is determined that a detailed description of a related known configuration or function may obscure the subject matter of the present invention the detailed description thereof will be omitted. In addition, a preferred embodiment of the present invention will be described below, but the technical idea of the present invention is not limited or limited thereto, and may be modified and variously implemented by a person skilled in the art.

Hereinafter, preferred embodiments according to the present invention will be described in detail with reference to the accompanying drawings.

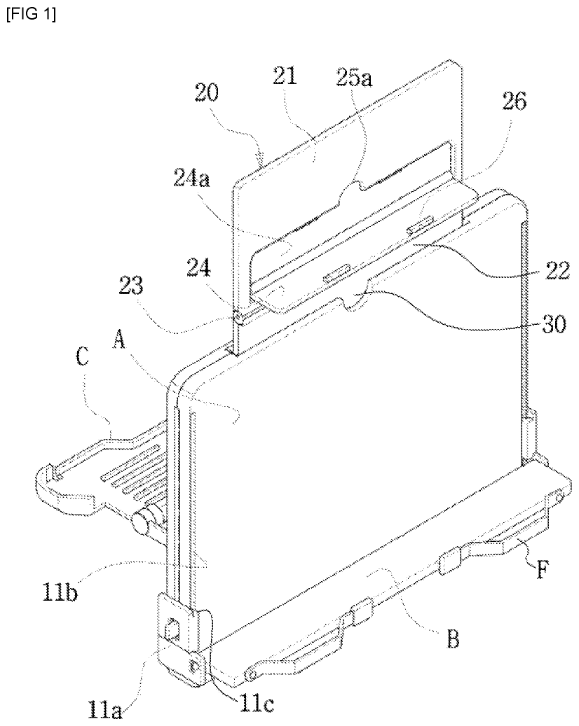

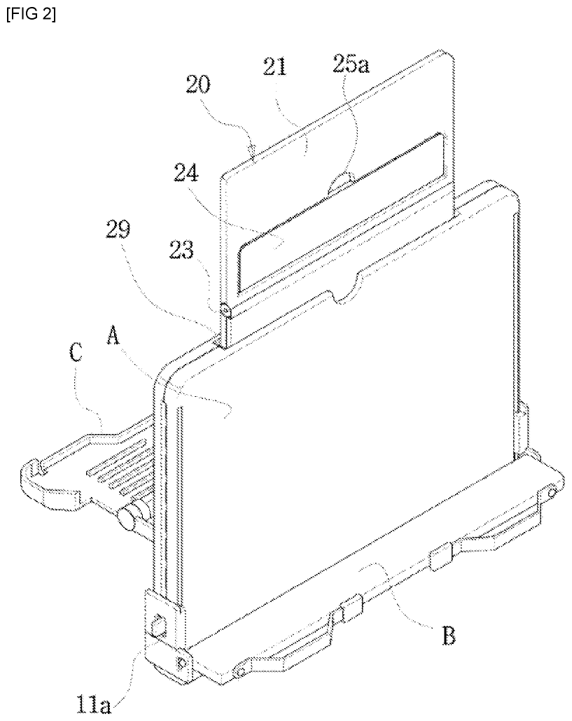

FIGS. 1 to 5 show a cradle having a height adjustment function. As shown, the cradle of the present invention includes a top plate (A), a bracket (B), a bottom plate (C), and a clip (11a) for adjusting the height of the bracket (B).

The bracket (B) is connected to the top plate (A) by a clip (11a) and is able to move up and down along the clip rail (11f) formed on the top plate (A). The clip (11a) is provided with a fixing device capable of fixing the height of the bracket (B), and combines the top plate (A) and the bracket (B).

The clip (11a) is configured as a click button type, and is installed on the left and right sides of the top plate (A), and the height is adjusted by lifting the bracket (B) from the front of the top plate (A).

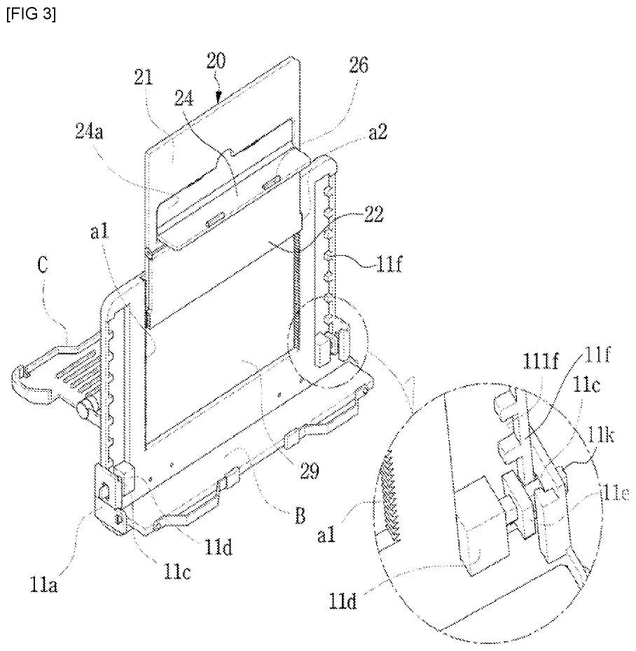

That is, referring to FIGS. 3 to 5, a clip rail (11f) into which a fixing device can be inserted is formed on the left and right sides of the top plate A. The fixing device includes a rail fixing clip (11d) and a button (11k), and an elastic member (11g) such as a spring can be disposed inside the rail fixing clip (11d) or between the rail fixing clip (11d) and the button (11k).

A rail fixing groove (111f) capable of adjusting and fixing the height of the bracket B using a fixing device is formed in the clip rail (11f) of the top plate (A).

The button (11k) is formed with a rail fixing protrusion (11e) that can be caught in the rail fixing groove (111f) of the clip rail (11f). A part of the button (11k) is exposed to the outside and may function as a handle that the user can hold, pull, or push in by hand.

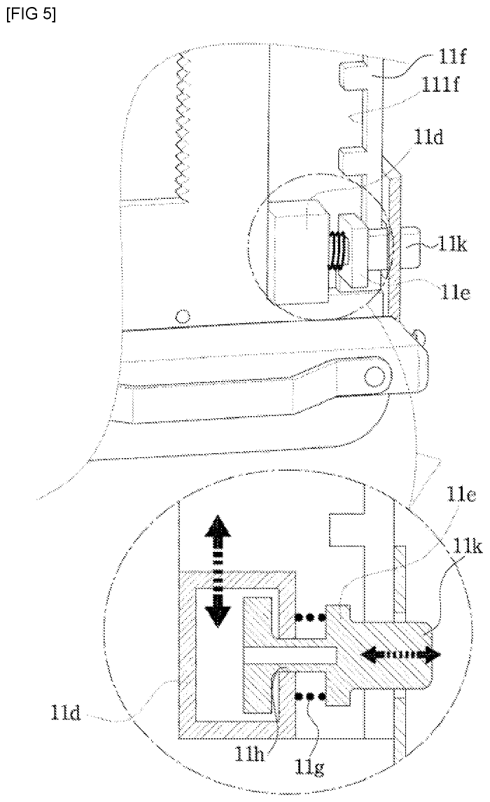

Referring to FIG. 5, an elastic member (11g) may be positioned inside the rail fixing clip (11d) or between the rail fixing clip (11d) and the rail fixing protrusion (11e) to provide elastic force to the button (11k). Accordingly, in a state in which the button (11k) is not pressed by an external force, the rail fixing protrusion (11e) of the button (11k) may be inserted and fixed in the rail fixing groove (111f) formed in the clip rail (11f).

The above-described clip rail (11f) may be formed not only inside as well as outside of the top plate (A), and the clip (11a) moves up and down along the clip rail (11f). In addition, the clip (11a) may be fixed to a vertically moved height at the top plate (A) by a fixing device provided on the clip (11a).

In addition, as shown in FIGS. 1 and 3, a hook fixing groove (11b) is formed in the top plate (A), and a clip fixing hook (11c) is formed in the clip (11a).

The hook fixing grooves (11b) may be formed on both front and rear edges of the top plate (A). The hook fixing groove (11b) is coupled with the clip fixing hook (11c) to prevent the clip (11a) from being separated when the clip (11a) moves up and down along the clip rail (11f).

The part to which the bracket (B) and the clip (11a) are connected becomes a rotating shaft, and the bracket (B) is rotatably coupled with the clip (11a Accordingly, the bracket (B) may be overlapped in parallel on the front surface of the top plate (A) through rotation, or may be unfolded while forming an approximately vertical surface with the top plate (A). On one side of the bracket (B), a book holder (F) is rotatably coupled at one end to fix the front of item such as a book on the bracket (B) with the other end.

It will be described in detail the height adjustment method by the height adjustment configuration of the bracket configured as described above.

As shown in FIG. 5, in order to adjust the height of the bracket (B), a push pressure is applied to the button (11k) of the clip (11a) coupled to both sides of the bracket (B). Then, as the elastic member (11g) is compressed, the rail fixing protrusion (11e) is separated from the rail fixing groove (111f) formed in the clip rail (11f) of the top plate (A). Accordingly, as the rail fixing protrusion (11e) is separated from the rail fixing groove (111f) of the clip rail (11f), the position fixing of the bracket (B) is released. And the bracket (B) is converted to a state that can move up and down along the vertical direction of the top plate (A).

Next, while the user keeps the button (11k) pressed, the user moves the bracket (B) to a height at which he wants to fix the bracket (B) through the vertical movement of the bracket (B). Thereafter, when the user removes the pressure of the button (11k), the elastic member (11g) returns the button (11k) to its original position by the elastic restoring force. Accordingly, the rail fixing protrusion (11e) is again inserted into the rail fixing groove (111f) of the clip rail (11f), and the bracket (B) is fixed at the position of the adjusted height. In this way, the position (height) of the bracket (B) is adjusted and fixed.

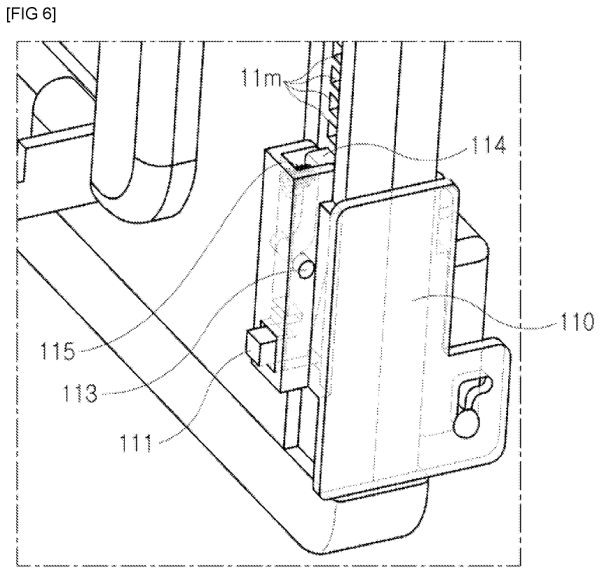

FIGS. 6 to 8 show another modified example of the configuration for adjusting the height of the bracket in the cradle of the present invention, and show that a rail and a button-type fixing device are formed on the left and right rear surfaces of the top plate.

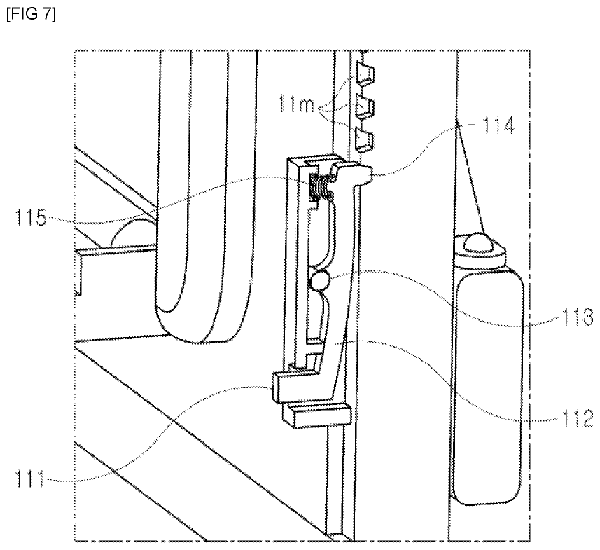

FIG. 6 is a perspective view of a state in which a rail and a button-type fixing device are formed on the left and right rear surfaces of the top plate. FIG. 7 is a cross-sectional perspective view of a portion of the fixing device in FIG. 6 cut in the longitudinal direction. The lower end of the fixing bar body (112) serves as the clip button (111), and the upper end of the fixing bar body (112) serves as the fixing bar insertion part (114). The rear surface of the fixing bar insertion part (114) has an elastic member fixing protrusion (115a) and an elastic member, which serves to push the fixing bar insertion portion in the direction of the rail groove 11m. At this time, the elastic member fixing protrusion (115a) serves to prevent the elastic member (115) from being separated from other places.

A fixing bar hinge (113) is formed in the middle of the fixing bar body (112). The fixing bar hinge (113) acts as a lever when a pressure is applied to the clip button (111), and the fixing bar insertion portion (114) is separated from the rail groove (11m). Thus, the lock of the clip (110) is released. When the pressure on the clip button (111) is removed, the fixing bar insertion part (114) is pushed in the direction of the rail groove (11m) by the elastic force of the elastic member (115) formed on the rear side of the fixing bar insertion part (114) and inserted in the rail groove (11m). Thus, the clip (110) is locked.

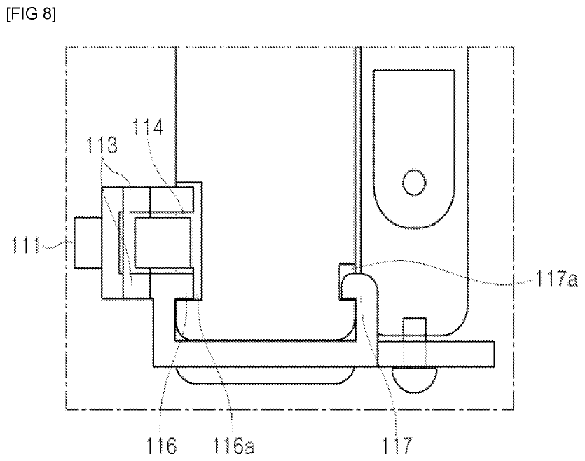

FIG. 8 is a cross-sectional view showing a portion of the fixing device in FIG. 6 cut in the transverse direction. The clip (110) may be formed with a front hook (117) and a rear hook (116) so that the clip (110) is not separated from the top plate (A) in the side. In addition, the rail groove (11m) and the rear hook groove (116a) are formed at the left and right rear edges of the top plate, and the front hook groove (117a) is formed at the left and right front edges of the top plate. The rear hook (116) is hooked to the rear hook groove (116a), and the front hook (117) is hung in the front hook groove (117a). Therefore, when the height of the clip or the bracket is adjusted up and down, the clip (110) may not be separated from the top plate (A).

The height adjustment method according to the height adjustment configuration described above will be described in detail. The cradle includes a top plate (A), a bracket (B), a clip (110) for adjusting the height of the bracket (B).

A Plurality of rail grooves (11m) is installed on the left and right sides of the rear surface of the top plate (A). When pressure is applied to the clip button (111) formed on the clip (110), the fixing bar hinge (113) acts as a lever. Accordingly, the fixed bar insertion part (114) inserted into the rail groove is separated from the rail groove (11m). Thus, the clip is unlocked. At this time, the height of the clip (110) or the bracket (B) may be adjusted to a desired height. And when the pressure applied to the clip button (111) is removed at a desired position (height), the elastic member pushes the clip button in the direction of the rail groove by the elastic force of the elastic member (115). Accordingly, the clip button (111) is inserted into the rail groove 11m, and the clip (110) or the bracket (B) is fixed at a specific height.

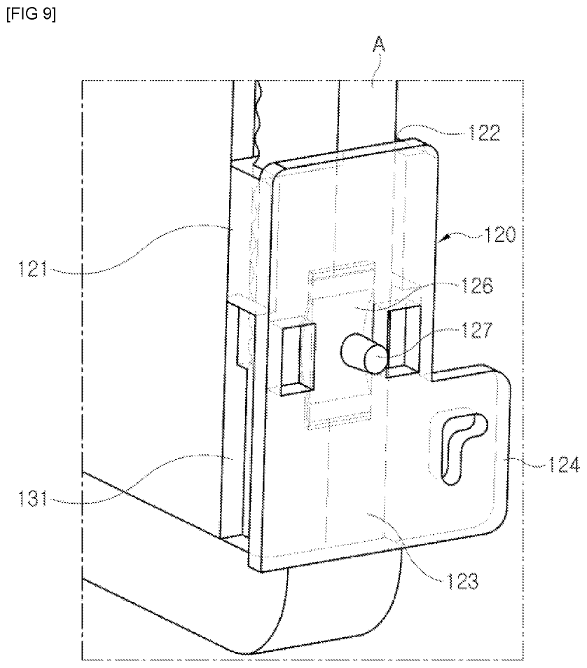

FIGS. 9 to 12 show another modified example of the height adjustment configuration of the bracket in the cradle of the present invention.

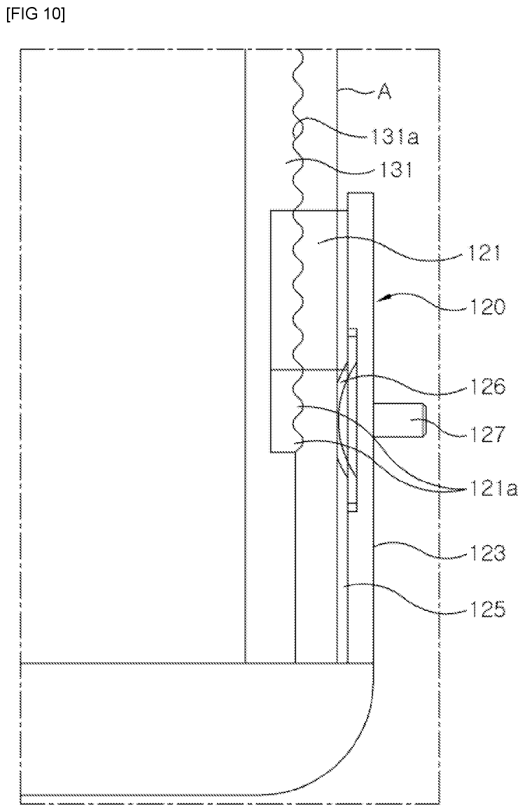

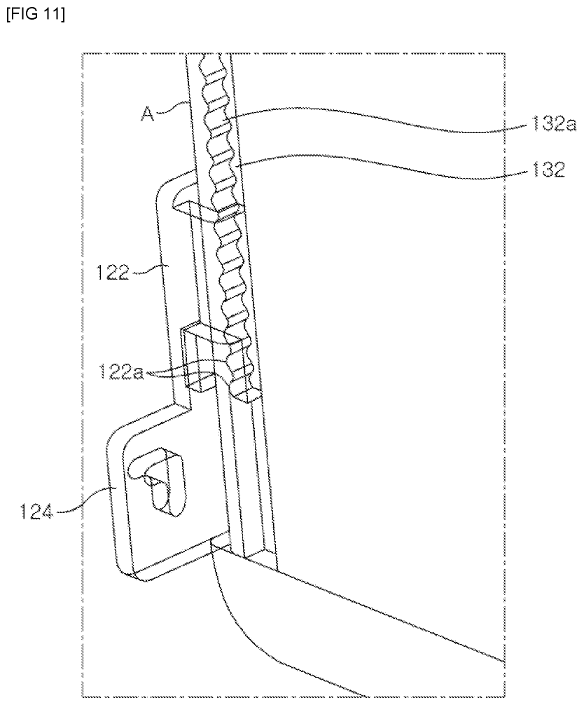

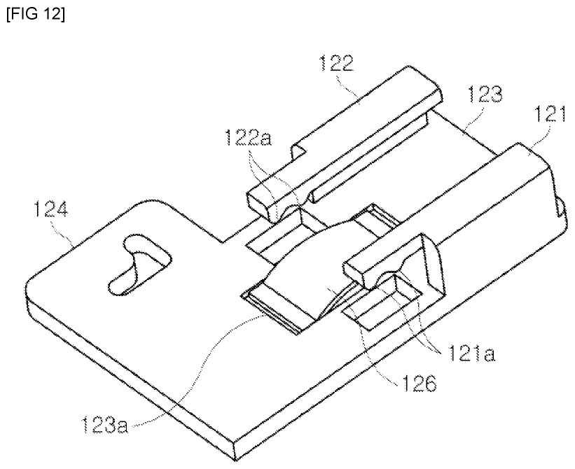

FIG. 9 is a perspective view of a main part showing another form of the height adjustment configuration of the bracket in the present invention, and is a perspective view of the height adjustment cradle to adjust the height of the clip or bracket by the elastic force of the plate spring. FIG. 10 is a rear view of the clip showed from the back of the top plate in FIG. 9. FIG. 11 is a perspective view of the clip showed from the front of the top plate in FIG. 9, and FIG. 12 is a perspective view showing the installation state of the plate spring of the clip in FIG. 9.

As shown in FIG. 9, guide grooves (131 and 132) are formed on both front and rear surfaces of the top plate (A) in the height adjustment direction (up and down directions) of the bracket. In addition, the clip (120) is installed to be movable up and down in the guide grooves (131 and 132).

The clip (120) includes a rear support part (121), a clip body (123), and a connection part (124). The rear support part (121) is formed in a′ shape in a cross section and is inserted into the guide groove (131) on the rear side of the top plate (A). The clip body (123) is provided with a front support part (122) inserted into the front guide groove (132) of the top plate (A). The connection part (124) is formed integrally with the clip body (123) in a configuration for coupling the bracket (B).

As shown in FIG. 10, a locking holding groove (131a) is continuously formed along the guide groove (131) on one side of the guide groove (131) on the rear side of the top plate (A). The rear support part (121) of the clip (120) is formed with a plurality of locking protrusions (121a) that can be fitted to each other in correspondence with the locking holding groove (131a). At this time, the rear support part (121) and the locking protrusion (121a) also serve as a hook so that the clip (120) is not separated from the top plate (A). In addition, the locking holding groove (131a) and the locking protrusion (121a) may be formed in a semicircular shape.

As shown in FIG. 9, a locking holding groove (132a) is continuously formed along the guide groove (132) on one side of the guide groove (132) on the front side of the top plate (A). The front support part (122) of the clip (120) is formed with a plurality of locking protrusions (122a) that can be fitted to each other in correspondence with the locking holding groove (132a). At this time, the front support part (122) and the locking protrusion (122a) also serve as a hook so that the clip (120) is not separated from the top plate (A). In addition, the locking holding groove (132a) and the locking protrusion (122a) may be formed in a semicircular shape.

In addition, as shown in FIG. 10, a predetermined gap 125 is formed between the side surface of the top plate (A) and the clip body (123) of the clip (120), and a plate spring (126) is installed in the gap (125).

As shown in FIGS. 9 and 12, the plate spring (126) is fitted into the mounting groove (123a) formed inside the clip body (123), and both ends of the plate spring are supported. The central portion of the plate spring is convexly curved, and the convexly curved portion is installed in close contact with the side surface of the top plate (A).

At this time, on the outer surface of the clip body (123), a gripping part (127) capable of simultaneously performing a handle function and a pressing function is formed at a position capable of pressing the convexly curved portion of the plate spring (126).

According to such a height adjustment configuration of the bracket, as shown in FIGS. 9 to 11, when the clip (120) is installed on the top plate (A), the elastic force of the plate spring (126) affects the clip body (123). Accordingly, the clip body (123) receives a force in a direction away from the side of the top plate (A). Accordingly, the locking protrusions (121a and 122a) of the rear support part (121) and the front support part (122) are inserted into the corresponding locking grooves (131a and 132a) so that the position of the bracket (B) is maintained in a fixed state.

In this state, in order to adjust the height of the bracket (B), the user holds the gripping part (127) of the clip body (123) and presses it toward the side of the top plate (A) and applies force in the vertical direction. Then, as the convex portion of the plate spring (126) is pressed, the clip body (123) can be moved in the vertical direction along the side surface of the top plate (A). Accordingly, the locking protrusions (121a and 122a) of the rear support part (121) and the front support part (122) are separated from the corresponding locking grooves (131a and 132a). Accordingly, the user can move the clip (120) and the bracket (B) connected thereto in the vertical direction along the guide grooves (131 and 132).

Therefore, after the user moves the bracket (B) to the desired height, when the user releases the holding part (127) pressed, the clip body (123) is moved away from the side of the top plate (A) by the elastic restoring force of the pressed plate spring (126). Accordingly, the locking protrusions (121a and 122a) of the rear support part (121) and the front support part (122) are inserted back into the corresponding locking grooves (131a and 132a). Thereby, the locking protrusions (121a and 122a) of the rear support part (121) and the front support part (122) are fixed by contacting the corresponding locking grooves (131a and 132a) again. Accordingly, the clip (120) and the bracket (B) connected thereto can be maintained in a fixed state at the height-adjusted position.

Referring back to FIGS. 1 to 4, the cradle of the present invention further includes an auxiliary plate (20). The top plate (A) is formed with an auxiliary plate insertion part (29) capable of accommodating the auxiliary plate (20), the auxiliary plate (20) is configured to be pull upward the upper side of the top plate (A) by an external force, so that the height of the top plate can be expanded.

In addition, the auxiliary plate (20) may be provided with an auxiliary bracket (24) unfolded substantially vertically from the front of the top plate. An electronic portable device or other item may be supported on the auxiliary bracket (24). The auxiliary bracket (24) may be provided with a locking bump (26). The locking bump (26) serves to prevent the item supported on the auxiliary bracket (24) falling down.

The auxiliary bracket (24) may be accommodated in the insertion groove (24a) installed in the front of the auxiliary plate (20).

Since a rotation hinge is formed on both sides of the lower end of the auxiliary bracket (24), the auxiliary bracket (24) can be unfolded by being inserted into the insertion groove (24a) or folded.

A finger groove (25a) is provided in the middle of the upper edge of the insertion groove (24a), and a locking bump (26) is provided at both edge of the auxiliary bracket (24). The position of the finger groove 25a may be changed.

In addition, the auxiliary plate (20) may be used as an extension support plate of the top plate in a cradle having a height adjustment function. In other words, when the bracket (B) moves upward and increases in height, an extension support plate for the top plate that serves to support the back of a book or item is required. The auxiliary plate (20) serves as an extension support plate of the top plate.

The auxiliary plate (20) is divided into an upper auxiliary plate (21) and a lower auxiliary plate (22), and may be coupled by a rotation hinge (23). At this time, the rotation hinge (23) also serves to adjust the angle of the auxiliary plate (20) separately from the top plate. The angle of the upper auxiliary plate (21) can be adjusted using the rotation hinge, and the angle between the upper auxiliary plate (21) and the lower auxiliary plate (22) can be adjusted so that the angle does not exceed 180 degrees. Accordingly, the item can be more stably supported on the auxiliary plate.

Meanwhile, the auxiliary plate (20) has a structure capable of maintaining the adjusted height when the height is adjusted.

The auxiliary plate (20) has a locking protrusion (a2) formed on both sides of the lower end, and the auxiliary plate insertion part (29) has a locking bump groove (a1) formed on both sides of the auxiliary plate corresponding to the locking protrusion (a2). Therefore, since the locking protrusion (a2) of the auxiliary plate (20) is inserted into the locking bump groove (a1) of the auxiliary plate insertion part (29), the locking of the auxiliary plate is maintained, and the auxiliary plate (20) can be fixed at a height pulled upward.

It is obvious that the positions of the locking bump groove (a1) and the locking protrusion (a2) may be changed to each other according to the implementation.

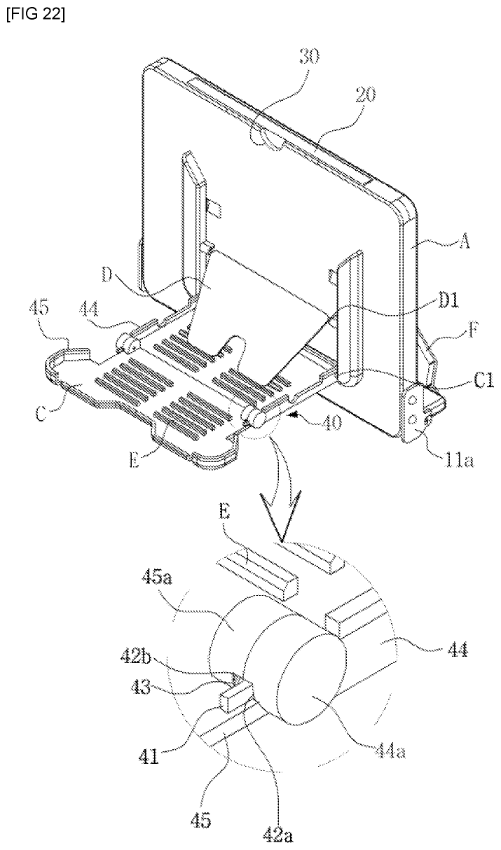

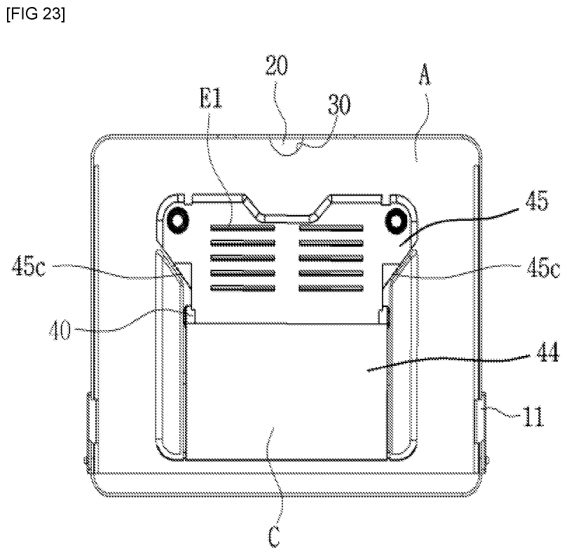

Referring to FIGS. 22 and 23, the auxiliary plate (20) is inserted into the auxiliary plate insertion part (29) of the top plate (A). The auxiliary plate (20) may be completely inserted and stored inside the auxiliary plate insertion part (29) of the top plate (A) so that it is not visible from the outside except for the upper surface.

The auxiliary plate (20) may be stored inside or protruded to the outside through an opening formed in the upper portion of the auxiliary plate insertion part (29). A grip groove (30) may be provided in the opening of the auxiliary plate insertion part (29). Accordingly, the user can easily protrude the auxiliary plate (30) outward by holding and pulling the upper central portion of the auxiliary plate (20) with a finger through the grip groove (30).

The auxiliary plate (20) may be completely pulled out from the auxiliary plate insertion part (29) of the topr plate (A) by the height of the auxiliary plate (20) in the upper direction and fixed to the upper portion of the top plate (A).

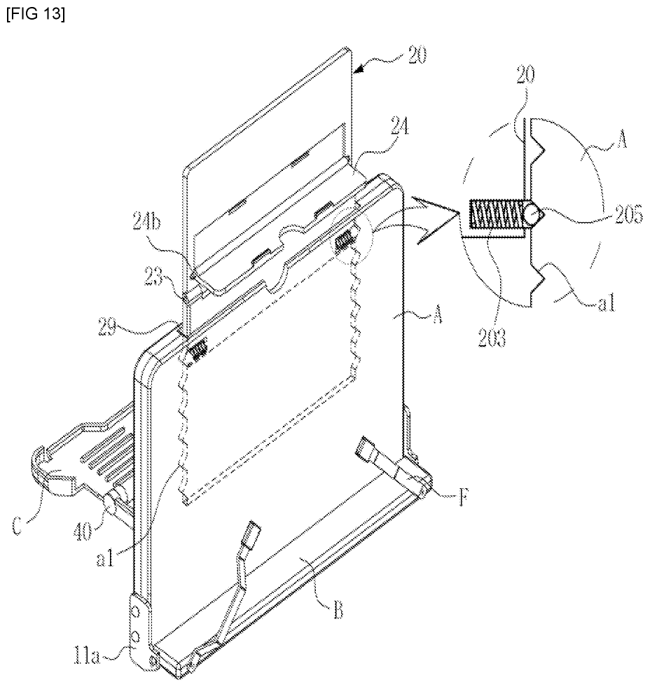

FIG. 13 is a perspective view showing another form of height adjustment configuration of the auxiliary plate in the cradle of the present invention, and showing the height adjustment of the auxiliary plate using a ball, an elastic body, and a locking bump groove.

Referring to FIG. 13, the auxiliary plate insertion part (29) has a locking bump groove (a1) therein. The locking bump groove (a1) restricts the vertical movement of the auxiliary plate (20) when the locking structure integrally installed under the auxiliary plate (20) is inserted. The locking structure is composed of an elastic body (203) inserted into the auxiliary plate (20) and a fixing ball (205) coupled to the distal end of the elastic body (203). According to this configuration, the elastic body (203) has a pressure to push the fixing ball (205) out. Thereby, when the fixing ball (205) meets the inner locking bump groove (a1), the fixing ball (205) is inserted into the locking bump groove (a1), and the vertical movement of the auxiliary plate (20) is restricted. Accordingly, the auxiliary plate (20) is fixed at a height lifted upwards.

The fixing ball (205) is installed to press the inner side of the auxiliary plate insertion part (29) with a predetermined pressure by the elastic force of the elastic body (203). After the fixing ball (205) is inserted into the locking bump groove (a1), when a force of more than a certain pressure is applied, the fixing ball (205) presses the elastic body (203) and naturally comes out from the locking bump groove (a1). To this end, the locking bump groove (a1) may have a V-shaped groove or an arc-shaped groove.

At least one or more of the aforementioned locking bump grooves (a1) may be formed in the inner space of the top plate (A), that is, on both sides of the auxiliary plate insertion part (29) or on other inner walls. One or more elastic bodies (203) and fixed balls (205) may be installed at the lower end of the auxiliary plate (20). When the auxiliary plate (20) is moved in the upper or lower direction of the top plate (A), the fixing ball (205) elastically installed on the auxiliary plate (20) by the elastic body (203) is caught in the inner locking bump groove (a1). Therefore, the auxiliary plate (20) is fixed in the elevated position.

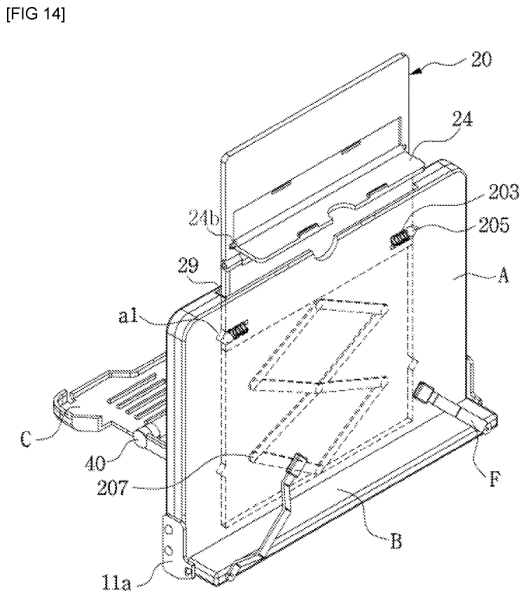

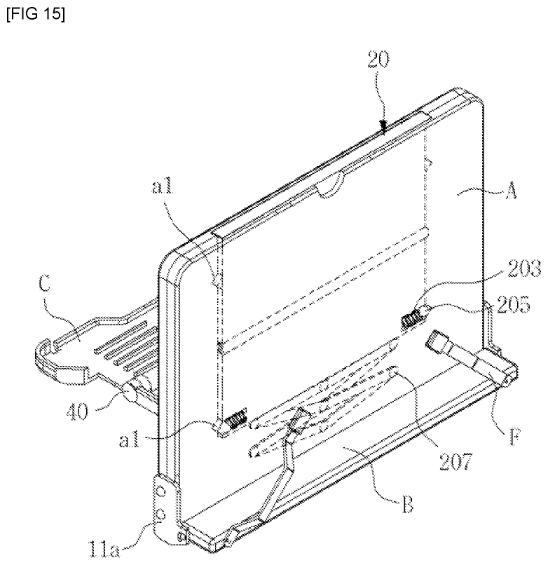

FIGS. 14 and 15 show another form of a configuration for adjusting the height of the auxiliary plate in the cradle of the present invention. The auxiliary plate (20) further includes a pantograph (207) installed at the lower end. The pantograph (207) may be referred to as ‘accordion shape’.

The pantograph (207) is inserted into the auxiliary plate insertion part (29). The lower end of the pantograph (207) is fixedly installed at the bottom of the auxiliary plate insertion part (29), and the upper end of the pantograph (207) is fixedly installed at the lower end of the auxiliary plate (20).

The pentagraph (207) may have a joint-type link structure that is unfolded or folded according to an elevating motion of the auxiliary plate (20) in the protruding direction of the auxiliary plate (20).

According to the configuration of the pantograph (207) according to the present embodiment, the lowering structure of the pantograph (207) coupled to the lower portion of the auxiliary plate (20) together with the function of the locking bump groove (1a), the elastic body (203) and the fixing ball (205) can make the operation of internal storage and pulling out of the auxiliary plate (20) safer and smoother.

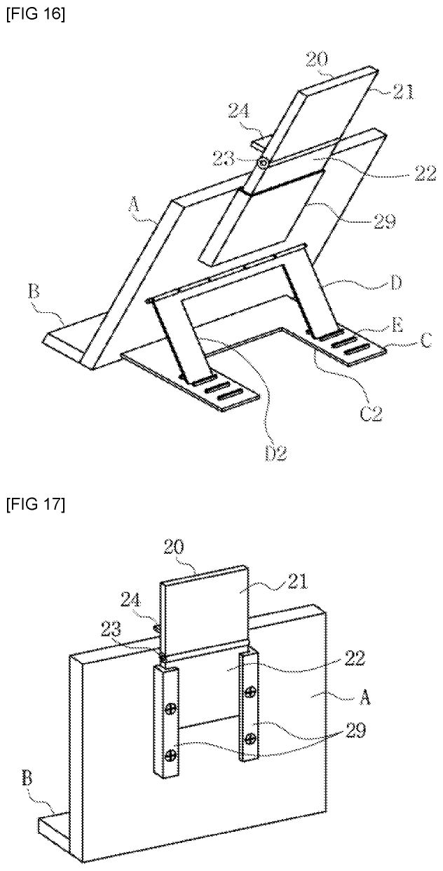

FIGS. 16 and 17 show different forms of the auxiliary plate insertion part, in which the auxiliary plate insertion part (29) is formed on the rear surface of the top plate (A).

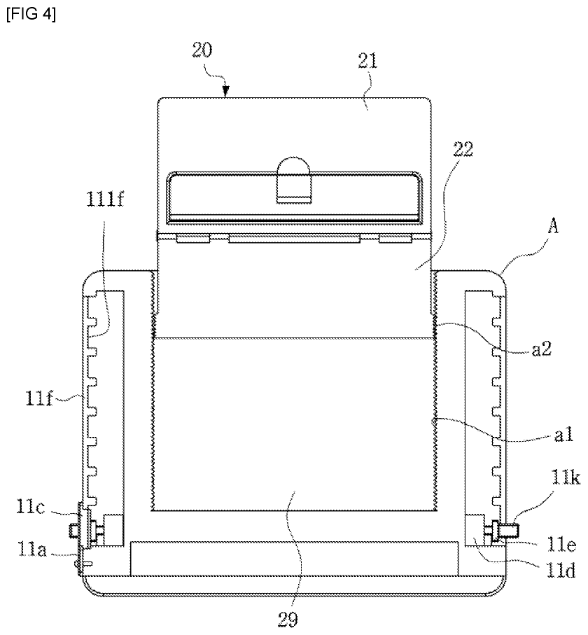

Referring to FIG. 16, the auxiliary plate insertion part (29) may be arranged to cover the entire rear surface or a part of the rear surface of the top plate A by a separate configuration from the top plate. The auxiliary plate insertion part (29) may not be formed inside the top plate, but may be coupled to the rear surface of the top plate to have a box shape having an opening thereon. At this time, in order to adjust and fix the height of the auxiliary plate (20), as shown in FIGS. 3 to 4 the auxiliary plate has locking protrusions formed on both left and right sides of the auxiliary plate, and locking grooves are formed on the left and right inner surfaces of the auxiliary plate insertion part, so that the height of the auxiliary plate can be fixed.

At this time, since the auxiliary plate insertion part (29) is formed on the rear surface of the top plate (A), interference may occur when the bottom plate (C) and the angle support (D) are folded to the rear surface of the top plate (A). Therefore, it is preferable that the bottom plate (C) and the angle support (D) have openings (C2 and D2) such that they do not come into contact with the auxiliary plate insertion part (29).

FIG. 17 shows another form of the auxiliary insertion part in the cradle of the present invention. The auxiliary plate insertion part (29) is formed on the rear surface of the top plate (A), but an opening is formed on the rear surface of the auxiliary plate insertion part (29) so that the rear surface of the auxiliary plate (20) is exposed to the outside.

In addition, the auxiliary plate insertion part (29) may be formed on the rear surface of the top plate (A) to support both sides of the auxiliary plate (20). Referring to FIGS. 3 and 4, in order to adjust and fix the protruding height of the auxiliary plate 20, locking protrusions may be formed on both left and right sides of the auxiliary plate, and locking bump grooves may be formed on the left and right inner surfaces of the auxiliary plate insertion part (29). Thus, the auxiliary plate can be fixed at a certain height.

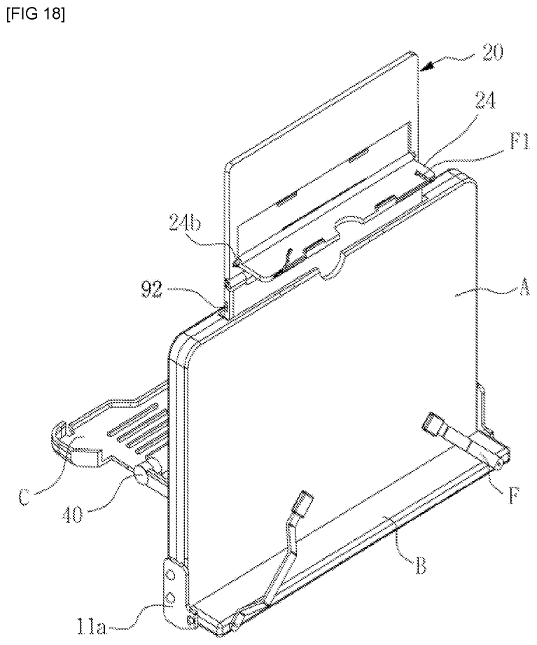

FIG. 18 is another modified example of the auxiliary plate in the cradle of the present invention. A book holder (F1) is additionally installed on the auxiliary bracket (24) of the auxiliary plate (20) to increase user convenience.

The book holder (F1) may be coupled to the side of the auxiliary bracket (24). The book holder (F1) serves to press and fix the page of the book when placing the book on the auxiliary plate.

When the auxiliary bracket insertion groove (24a) is formed slightly larger than the auxiliary bracket, the auxiliary bracket (24) may be inserted into the auxiliary bracket insertion groove (24a) without the book holder (F1) being caught on the auxiliary plate.

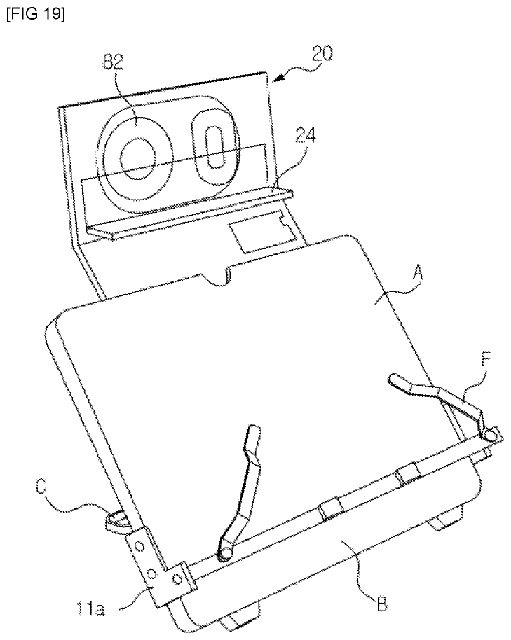

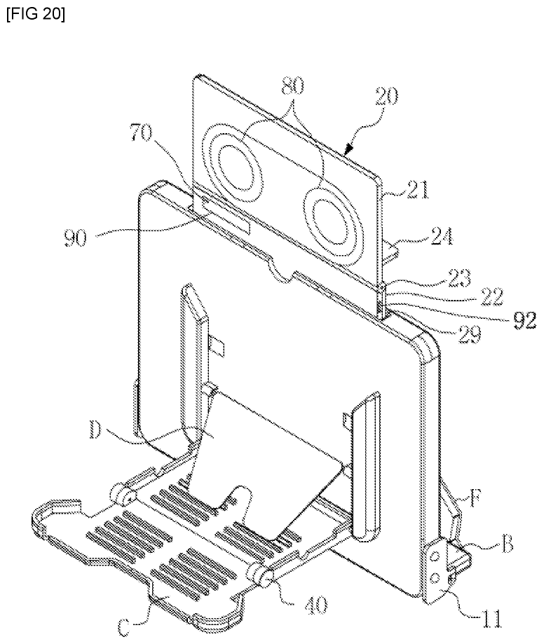

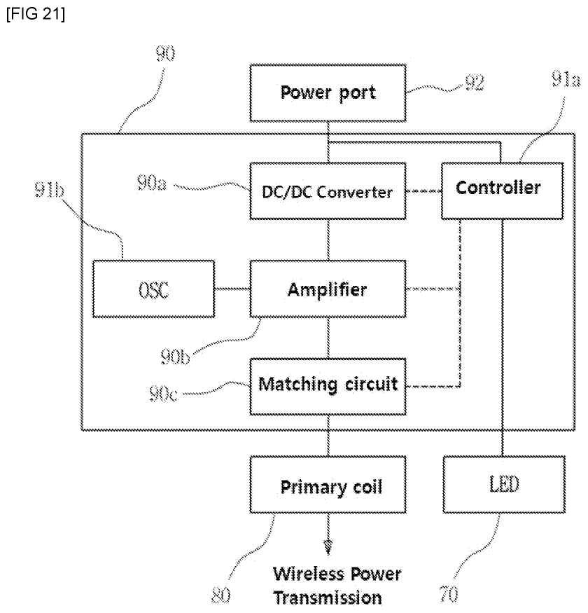

FIGS. 19 to 21 show another modified example of the auxiliary plate in the cradle of the present invention. The auxiliary plate (20) is provided with a wireless charging unit. In this case, the cradle may further include a light emitting diode (70) and a power port (92).

The wireless charging unit is installed on the top plate (A) or the auxiliary plate (20). The wireless charging unit includes a primary coil (80) and a PCB circuit board (90), and the PCB circuit board (90) can include a DC/DC converter (90a), an amplifier (90b), a matching circuit (90c), and a controller (91a) and an oscillator (OSC, 91b).

The primary coil (80) is a transmitter coil for wireless power transmission of a magnetic induction method or a magnetic resonance method, and a structure according to a coil design having excellent quality factors supported by wireless power cosortium (PC) and alliance for wireless power (A4WP) may be provided. A predetermined pattern (82) or the like may be displayed on the surface of the auxiliary plate (20) of the corresponding portion of the primary coil (80).

The controller (91a) converts an external power or commercial power input through the power port (92) into a voltage and current suitable for input to the amplifier (90b) through the control of the DC/DC converter (90a). In addition, the controller (91a) controls a change in the impedance of the amplifier (90b) facing the secondary side according to the change in the impedance of the electronic device. Here, the controller (91a) measures a change in impedance based on detection information of voltage and current that can change according to the electronic device to be charged with wireless. When an impedance change of the electronic device (that is, a change in voltage and current on the secondary side) occurs, the controller (91a) controls the amplifier (90b) and the matching circuit (90c). Accordingly, wireless power matched with the impedance of the secondary side can be transmitted through the primary coil (80).

In addition, the controller (91a) may control the operation of the light emitting diodes (LED) (70). In particular, the charging status of the electronic device being wirelessly charged is displayed through the LED, so that the user can conveniently check the wireless charging status.

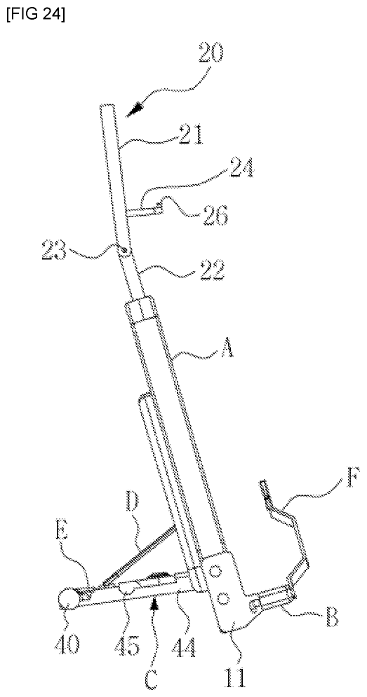

The power port (92) may include a universal serial bus (USB) port. The power port (92) may be referred to as a power terminal or simply a terminal, and may be replaced with various types of mini or micro terminals or power plugs. In FIGS. 23 and 24, the power port (92) is disposed on the left side of the lower auxiliary plate (22) in the auxiliary plate (20), but is not limited thereto, and may be installed on the right side of the lower auxiliary plate (22).

The auxiliary plate (20) is provided with an auxiliary bracket mounted in a folding and unfolding manner on its front side. In addition, a light emitting diode (70) may be installed on the auxiliary plate (20).

According to the above configuration, the user can check the charging state by the light emitting diode (70) while placing the smartphone on the auxiliary bracket (24) of the auxiliary plate (20) and charging wirelessly. At the same time, the user can read the book by placing it on the top plate (A) and the bracket (B). Therefore, user convenience can be maximized.

In addition, according to the configuration of the wireless charging unit of the present embodiment, since the cradle having the auxiliary plate can charge the battery of the electronic device by a wireless power method, the function of the auxiliary plate can be expanded. Therefore, since the cradle has multiple functions, it is possible to increase the usability of the cradle and increase user convenience.

Referring to FIG. 22, the cradle of the present invention further includes a bottom plate (C) and an angle support (D) provided on the back of the top plate (A). The bottom plate (C) and the angle support (D) are coupled to the rear surface of the top plate (A) and are installed to adjust the inclination angle of the top plate (A).

The bottom plate (C) and the angle support (D) are installed on the rear surface of the top plate (A) through each of the hinges (C1, D1) to enable rotational movement, respectively. The bottom plate (C) is formed with an angle fixing bump (E). The angle fixing bump (E) supports one end of the angle support (D) to adjust the inclination angle of the upper plate (A) or to fix the angle support (D).

FIG. 23 is a rear view showing a state in which the bottom plate (C) is folded and in close contact with the rear surface of the top plate (A). The lower floor plate has a separate fixing bump groove (E1) on the rear surface. At this time, the fixing bump groove (E1) may be formed to protrude outward, but may also be in the form of a recessed groove. The lower bottom plate (45) and the upper bottom plate (44) are coupled by bottom plate rotation hinges (44a and 45a), and can be rotated and folded due to the bottom plate rotation hinges.

FIG. 24 shows the cradle on which the auxiliary plate is pulled out. Here, after the auxiliary plate (20) is lifted from the inside of the top plate (A), it can be seen that the auxiliary bracket (24) is unfolded from the insertion groove (24a). And it can be seen that the angle of the auxiliary plate (20) is adjusted using the rotation hinge (23) formed on the auxiliary plate. And it can be seen that the angle support (D) is supported in the fixing bump groove (E1) formed on the rear surface of the lower bottom plate (45) after folding the lower bottom plate (45) on the upper bottom plate (44).

The angle fixing bump (E) is formed in a protrusion shape. As shown in FIGS. 23 and 24, the lower bottom plate (45) may have a fixing bump groove (E1) formed in an intaglio shape on its rear surface. In this case, the lower bottom plate (45) may be used to adjust and support the inclination angle of the top plate (A) by supporting the angle support in both the unfolded or folded state of the bottom plate (C).

When such a bottom plate (C) and an angle support (D) are used in a narrow space such as a desk in a reading room, the bottom plate (C) can be folded and used. Therefore, it is possible to use the desk efficiently by reducing the width of the bottom plate.

Referring back to FIG. 22, FIG. 22 is a rear perspective view of the cradle having a bottom plate having a fixing lock device using a fixing bar.

The bottom plate (C) has hinge parts (44a and 45a) in the middle of the bottom plate, and the bottom plate (C) can be folded or unfolded by the hinge parts (44a and 45a). That is, the bottom plate (C) is provided with an upper bottom plate (44) and a lower bottom plate (45), hinge parts (44a, 45a) for hinge-joining them, and a fixing lock device that fixes the bottom plate in a folded or unfolded state.

When the lower bottom plate (45) is folded using the hinge device (40) as a rotation axis, the lower bottom plate (45) may be overlapped on the upper bottom plate (44). In this case, a configuration for minimizing the overlapping thickness of the upper and lower bottom plates (44 and 45) may be applied. In the overlapping portion, one component of the upper bottom plate (44) and the lower bottom plate (45) may be configured to be engaged with a concave part or the cutout part of the other component.

The hinge device (40) includes an upper bottom plate hinge part (44a), a lower bottom plate hinge part (45a), and a fixing lock device. The fixing lock device includes a fixing bar (41), a fixing lock groove (42a), a spring groove (42b), and a spring (43)

The fixing lock groove (42a) is formed in the upper bottom plate hinge part (44a) located on one side of the upper bottom plate (44), the spring groove (42b) is formed in the lower bottom plate hinge part (45a) located on one side of the lower bottom plate (45).

The fixing lock groove (42a) and the spring groove (42b) are arranged to face each other in the form of one rectangular opening. The spring (43) is inserted in the spring groove (42b). When there is no external force, the spring (43) restricts the rotation of the lower bottom plate (45) by pushing the fixing bar (41) into the fixing lock groove (42a).

According to this configuration, the fixing bar (41) is maintained in a state located in the fixing lock groove (42a) of the upper bottom plate hinge part (44a) by the elastic force of the spring (43). When the spring (43) is compressed by an external force, the fixing bar (41) is moved to the spring groove (42b) on the lower bottom plate hinge part (45a). Accordingly, the fixing bar (41) is released from the fixing lock groove (42a) and the lock state is released. As a result, the lower bottom plate (45) can be rotated with respect to the upper bottom plate (44) to be overlapped on the upper bottom plate (44). At this time, the fixing bar (41) contacts one surface of the lower bottom plate hinge part (45a) and rotates together with the rotation of the lower bottom plate (45).

On the other hand, in the embodiment of the present invention, the fixing lock groove (42a) is formed in the upper bottom plate hinge part (44a) of the upper bottom plate (44), and the spring groove (42b) is It is formed in the lower bottom plate hinge part (45a) of the lower bottom plate (45). However, it is not limited thereto. Although not shown, the fixing lock groove (42a) may be formed in the lower bottom plate hinge part (45a) of the lower bottom plate (45), and the spring groove (42b) may be formed in the upper floor plate hinge part (44a) of the upper bottom plate (44). In addition, the fixing lock device of the hinge device 40 may be installed only on one side or both sides of the bottom plate (C).

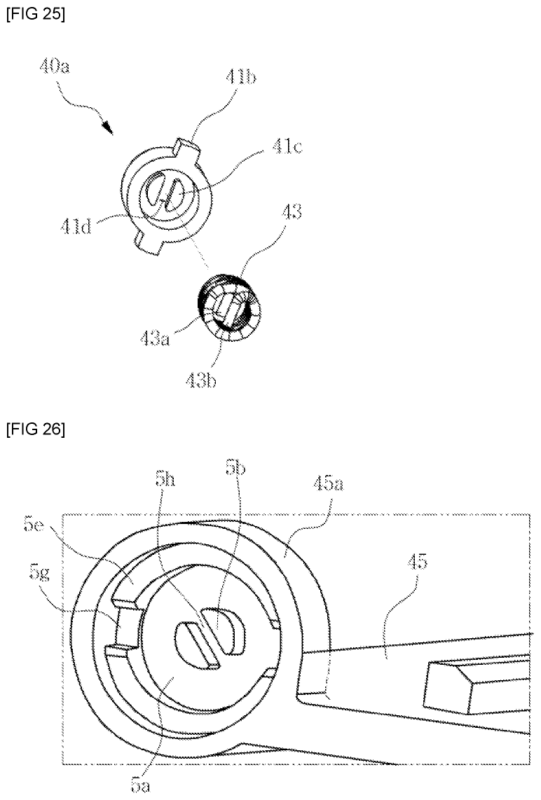

FIGS. 25 to 30 show another example of a hinge device in the cradle of the present invention. The cradle includes a push button having a fixing protrusion and a fixing lock device using an elastic body and a fixing groove.

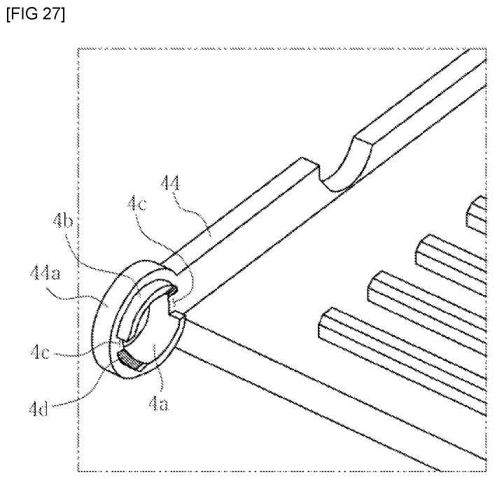

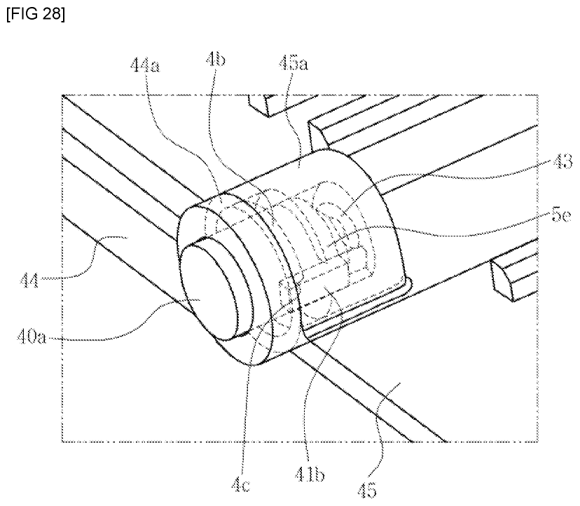

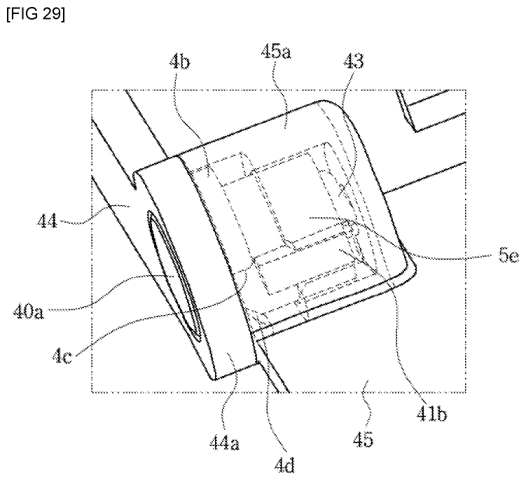

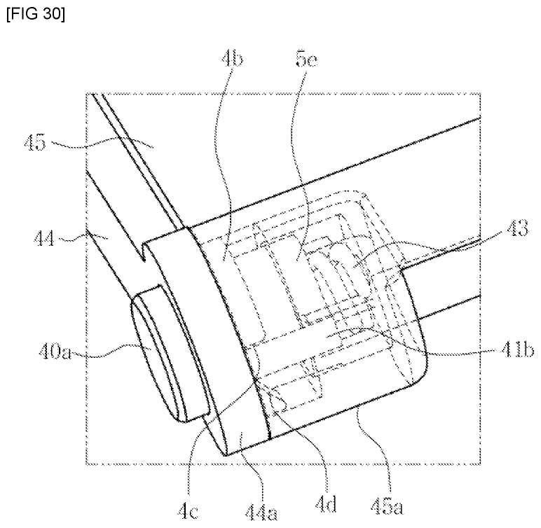

FIG. 25 is an perspective view of disassembled structure showing a push button and a spring, FIG. 26 is a perspective view showing the lower bottom plate hinge in FIG. 28, FIG. 27 is a perspective view showing the upper bottom plate hinge part in FIG. 28, and FIG. 28 is an internal perspective view showing a state in which the upper and lower bottom plates are unfolded at 180 degrees and locked according to another form of the hinge device and FIG. 29 is an internal perspective view of a state in which the push button of the hinge device is pressed, and FIG. 30 is an internal perspective view showing a state in which the lower bottom plate is folded to the upper bottom plate.

If described in more detail for each component, the hinge device (40) is composed of upper and lower bottom plate hinge part (44a, 45a) and a fixed lock device.

As shown in FIG. 25, the push button (40a) has a cylindrical shape with one side closed, and square fixing protrusions (41b) are formed on the outer surface of the push button at predetermined intervals. The spring fixing portions (41c) are formed to be spaced apart from each other and protrude from the inner bottom surface of the push button (40a). A spacing part (41d) of a predetermined width is provided between the two spring fixing parts (41c), and one end part (43a) of the spring (43) is inserted into the spacing part (41d).

As shown in FIG. 26, the lower bottom plate hinge part (45a) has an inner space (5a) for accommodating a part of the push button (40a) and a part of the spring (43), and is formed in a cylindrical shape with one side closed. A spring fixing part (5b) is formed on the bottom surface of the inner space (5a), which consists of a pair of protrusions formed to be spaced apart from each other. The other end part (43b) of the spring (43) is inserted into the spacing part (5h) in the spring fixing portion (5b).

In addition, the bump part (5e) is formed protruding from the bottom surface on the inner circumferential surface of the lower bottom plate hinge part (45a), and seating grooves (5g) are formed at predetermined intervals in the bump part (5e). And the fixing protrusion (41b) of the push button (40a) is inserted into the seating groove (5g).

As shown in FIG. 27, a through hole (4a) is formed in the upper bottom plate hinge portion (44a), and a push button (40a) is coupled through the through hole (4a). A fixing bump (4b) is formed in a ring shape at the edge of the through hole (4a). A fixing groove (4c) into which the fixing protrusion (41b) of the push button (40a) is inserted is formed in the fixing bump (4b) at predetermined intervals.

In addition, in the fixing bump (4b), one side of both fixing grooves (4c) is formed as an inclined surface (4d). Through this, the user can naturally rotate and unfold the lower bottom plate (45) overlapped with the upper bottom plate (44) without releasing the lock by pressing the push button (40a). The inclined surface (4d) is formed such that the opening of the fixing groove (4c) gradually increases in the unfolding direction of the lower bottom plate (45). Like the fixing bump (4b), the inclined surface (4d) exists in pairs.

In addition, it is possible to assemble to have the torsional elasticity of the spring (43) by fixing both end parts (43a and 43b) of the spring (43) in the inside of the push button (40a) and in the inside of the lower bottom plate hinge (45a). When the push button (40a) is pressed by this accumulated elastic force, the lower bottom plate (45) can be automatically folded on the upper floor plate (44). In addition, when the push button (40a) is pressed, elastic compression and elastic restoration are performed in the pressing direction.

As shown in FIGS. 25 and 30, when the push button (40a) is pressed, the fixing protrusion (41b) is released from the fixing groove (4c) and the lock state is released. Accordingly, the spring (43) is compressed and at the same time the lower bottom plate (45) is in a state capable of rotating with respect to the upper bottom plate (44). In addition, the lower bottom plate (45) is automatically folded onto the upper bottom plate (44) by the torsional elastic force of the spring (43).

In addition, when the pressing force of the push button (40a) is removed, the elastic restoring force of the spring (43) compressed on the fixing protrusion (41b) formed on the push button (40a) acts as shown in FIG. 30. Accordingly, the fixing protrusion (41b) is fixed and inserted into the fixing groove (4c) while returning to its original position.

There are two ways to unfold the lower bottom plate (45) again. First, if the user presses the push button (40a), the fixing protrusion (41b) is released from the fixing groove (4c) and the lock is released. While unfolding the folded lower bottom plate (45) by 180 degrees, the fixing protrusion (41b) is completely inserted into the seating groove (5g) and contacts one surface of fixing bump (4b) of the upper bottom plate, and rotates together with the rotation of the lower floor plate 45. During such rotation, when the lower bottom plate is completely unfolded by 180 degrees, the fixing protrusion (41b) meets the fixing groove (4c) again. And due to the elastic force of the spring (43), the fixing protrusion (41b) is inserted into the fixing groove (4c) again and the fixing lock is caught.

Secondly, without pressing the push button 40a, if the user unfolds the folded lower bottom plate (45), the lock can be automatically locked and fixed. In other words, When the user unfolds the folded lower bottom plate (45), the bump part (5e) of the lower bottom plate pushes the fixing protrusion (41b) partially inserted into the seating groove (5g) in the unfolding direction. At this time, the fixing protrusion (41b), which was also inserted into the opposite fixing groove (4c), is naturally completely inserted into the hinge part seating groove (5g) by the inclined surface (4d) formed on the upper bottom plate hinge part. Accordingly, the fixing protrusion (41b) contacts one surface of the fixing bump (4b) of the upper bottom plate and rotates together with the rotation of the lower bottom plate (45). During such rotation, when the lower bottom plate is completely unfolded by 180 degrees, the fixing protrusion (41b) meets the fixing groove (4c) again. And due to the elastic force of the spring (43), the fixing protrusion (41b) is inserted into the fixing groove (4c) again, and the fixing lock is caught.

In the above, it has been described with reference to a preferred embodiment of the present invention. It is obvious that those of ordinary skill in the art can variously modify and change the present invention without departing from the idea and scope of the present invention described in the following claims.

1. A multi-functional cradle including;
a top plate that supports the item to be placed on one side;
a bracket provided to protrude from a lower portion of one surface of the top plate to support a lower portion of the item;
an auxiliary plate which is pulled out from the upper part of the upper plate and includes an auxiliary bracket for supporting another item to be placed;
And a bottom plate unfolded to support the top plate at the rear surface of the top plate.

2. The multi-functional cradle according to claim 1, wherein the auxiliary plate comprises;
a insertion groove providing a space in which the auxiliary bracket can be accommodated.

3. The multi-functional cradle according to claim 1, wherein the auxiliary bracket of the auxiliary plate can be folded or unfolded by a hinge formed on the auxiliary plate, and can be unfolded in an approximately vertical direction from the front of the auxiliary plate.

4. The multi-functional cradle according to claim 1, wherein the auxiliary plate is composed of an upper auxiliary plate and a lower auxiliary plate; and the upper auxiliary plate and the lower auxiliary plate are coupled by a rotation hinge so that the angle of the auxiliary plate is individually adjusted.

5. The multi-functional cradle according to claim 3, wherein an outer surface of the auxiliary plate and an inner side surface of the auxiliary plate insertion part provided on the upper plate further include a locking bump groove and a locking protrusion.

6. The multi-functional cradle according to claim 5, wherein
the locking protrusion is composed of a ball and an elastic body.

7. The multi-functional cradle according to claim 1, wherein
the bottom plate is composed of an upper bottom plate and a lower bottom plate, and is coupled by a hinge part to allow the bottom plate to be folded or unfolded.

8. The multi-functional cradle according to claim 7, wherein
The hinge part includes a fixing lock device for fixing or releasing the fixing of the upper and lower floor plates by using the locking principle of the fixing protrusion and fixing groove with an elastic body.

9. The multi-functional cradle according to claim 1, wherein the cradle further includes;
an angle support for supporting between the bottom plate and the top plate,
the bottom plate and the angle support are each coupled to the rear surface of the upper plate at intervals by individual hinges, and can be independently rotated;
an angle fixing bump is formed on the bottom plate,
and the top plate is fixed to have a certain angle while the angle support is caught on the angle fixing bump,
and the bottom plate is provided with a hinge part so that the lower bottom plate can be folded and overlapped on the upper bottom plate,
A locking bump groove is formed on the bottom surface of the lower bottom plate, so that the angle support can be caught and supported on the locking bump groove even when the bottom plate is folded.

10. The multi-functional cradle according to claim 1, wherein the cradle comprises;
a clip coupled to the left and right of the top plate and moving the bracket up and down in the formation direction of the top plate and,
a fixing device that restricts the movement of the clip using a fixing protrusion and a fixing groove.

11. The multi-functional cradle according to claim 1, wherein the cradle further includes a book holder disposed on the auxiliary bracket of the auxiliary plate.

12. The multi-functional cradle according to claim 1, wherein the auxiliary plate further includes a wireless charging unit capable of wireless charging of an electronic portable device using a coil and a PCB circuit board

13. A multi-functional cradle including;
a top plate that supports the item to be placed on one side;
a bracket provided to protrude from a lower portion of one surface of the top plate to support a lower portion of the item and;
a bottom plate that is provided with a hinge so as to be folded or unfolded on the rear surface of the top plate, and is unfolded to support the top plate on the rear surface of the top plate;
and, wherein the bottom plate includes an upper bottom plate and a lower bottom plate, and the upper and lower bottom plates are coupled by a bottom plate rotation hinge.

14. The multi-functional cradle according to claim 13, wherein the rotation hinge includes;
a fixing lock device that
includes a fixing protrusion having an elastic body and a fixing groove through which the fixing protrusion is caught,
be capable of folding or fixing the bottom plate by the locking principle between the fixing protrusion and the fixing groove.

15. The multi-functional cradle according to claim 14, wherein the fixing protrusion is configured in the form of a fixing bar.

16. The multi-functional cradle according to claim 14, wherein the fixing protrusion is configured in the form of a fixing protrusion in which a push button is formed.

17. The multi-functional cradle according to claim 13, wherein the cradle further includes an angle support for supporting between the bottom plate and the top plate,
and the bottom plate and the angle support are each coupled to the rear surface of the upper plate at intervals by individual hinges, and can be independently rotated;
and an angle fixing bump is formed on the bottom plate;
and the top plate is fixed to have a certain angle while the angle support is caught on the angle fixing bump;
and the bottom plate is provided with a hinge part so that the lower bottom plate can be folded and overlapped on the upper bottom plate,
and a locking bump groove is formed on the bottom surface of the lower bottom plate.

18. The multi-functional cradle according to claim 13, wherein the cradle further includes an auxiliary plate pulled out from the top of the top plate and extending on the top plate,
and the auxiliary plate includes an auxiliary bracket supporting another item to be placed.

19. The multi-functional cradle according to claim 18, wherein the auxiliary plate has an auxiliary bracket insertion groove, and the auxiliary bracket of the auxiliary plate can be folded or unfolded by a hinge formed on the auxiliary plate, and is unfolded in a substantially vertical direction from the front of the auxiliary plate.

20. The multi-functional cradle according to claim 18, wherein the cradle further includes a pair of locking projection grooves and locking protrusions installed on an outer surface of the auxiliary plate and an inner surface of the auxiliary plate insertion part provided on the top plate.

21. The multi-functional cradle according to claim 18, wherein the auxiliary plate is composed of an upper auxiliary plate and a lower auxiliary plate,
and the upper auxiliary plate and the lower auxiliary plate are coupled by a rotation hinge to adjust the angle of the auxiliary plate.

22. The multi-functional cradle according to claim 13, wherein the cradle has height adjustment function and is provided with
a clip coupled to the left and right of the top plate and moving the bracket up and down in the formation direction of the top plate and,
a fixing device that restricts the movement of the clip using a fixing protrusion and a fixing groove.
